(19) United States
(12) Patent Application Publication
(10) Pub. No.: US 2006/0050474 A1
(43) Pub. Date: Mar. 9, 2006

(54) Computer with restriction feature for restricting user access

(76) Inventors: Hiroyuki Kusaka, Tokyo (JP); Hiroshi Nakamura, Tokyo (JP); Toshiyuki Tanaka, Austin, TX (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/937,615

(22) Filed: Sep. 8, 2004

(51) Int. Cl. G06F 1/16

(52) U.S. Cl. 361/683; 361/681

(57) ABSTRACT

According to one embodiment of the invention, an electronic device, a computer comprises a body case, a cover and a control unit. The cover is adapted to cover a single opening within a bottom panel of the body case and attachment thereto. The single opening is over a substantial area of the bottom panel. The control unit is configured to (i) control attachment of the cover to the body case and (ii) impose a restriction on user access based on the setting of the control unit.

### FIELD

Embodiments of the invention relate to the field of computers. More specifically, one embodiment of the invention relates to a computer with a mechanism that is adapted to control usage and access restrictions as well as to control removal of a single bottom cover providing access to internal hardware components within the main body of the computer.

### GENERAL BACKGROUND

Originally, computers were purchased and used only by large companies and universities. Over the past decade, there has been an increased demand for computers such that a high percentage of computers are now found in homes and schools.

Given this increased usage and the likely requirement that future members entering the work force must be familiar with computers, both parents and educators are beginning to expose young children to computers. In fact, within many of our communities, children in elementary schools and even preschools are now routinely being exposed to computers in both their classroom and their home.

Unfortunately, while computer technology has advanced significantly over the years, measures have not been taken to modify computers in order to address safety concerns for small children. Also, measures have not been taken to increase the structural durability of computers normally used by children, as well as to provide additional enhancements for restricting usage and access to various content.

### BRIEF DESCRIPTION OF THE DRAWINGS

Features and advantages of embodiments of the invention will become apparent from the following detailed description in which

FIG. 1 is a perspective view of an exemplary embodiment of computer, such as a notebook computer for example, placed in an operational state.

FIG. 2 is a top plan view of an exemplary embodiment of the bottom cover of the computer of FIG. 1.

FIG. 3 is an exemplary embodiment of a rotating dial of a locking mechanism positioned on the bottom cover of FIG. 2 and placed in a first position.

FIG. 4 is an exemplary embodiment of the computer of FIG. 2 with the bottom cover removed and exposing the locking mechanism placed in an unlocked position along with a lock detection switch and internal components.

FIG. 5 is an exemplary side view of the locking mechanism along with a lock detection switch and internal components shown in FIG. 4.

FIG. 6 is a first exemplary embodiment of the locking mechanism placed in a locked position.

FIG. 7 is a second exemplary embodiment of the locking mechanism placed in a locked position.

FIG. 8 is a cross-sectional view of the locking mechanism of FIG. 4.

### DETAILED DESCRIPTION

Embodiments of the invention set forth in the following description generally relate to a mechanism that is adapted to control removal of a single bottom cover that, when removed, provides access to internal hardware components within the main body of the computer. Moreover, in combination with a lock detection switch, the mechanism is adapted to identify when usage and access restrictions are warranted.

In the following description, certain terminology is used to describe various features of one or more embodiments of the invention. For instance, a “computer” is generally defined as a portable computer. Various types of portable computers include, but are not limited or restricted to a notebook personal computer (PC), a tablet PC, a personal digital assistant (PDA) and the like. In this detailed description, for clarity's sake, the computer is illustrated as a specific type of portable computer, namely a notebook PC. It is contemplated, however, that the invention may be implemented for use by any other type of computer.

A “logic component” is a hardware component, software component or any combination thereof. An example of a “hardware component” includes circuitry that is designed to supply power (e.g. battery) or operate based on electrical signal inputs (e.g., memory, hard disk drive, and the like). An example of a “software component” includes executable code in the form of an application, an applet, a routine or even a series of instructions. The software may be stored in any type of machine readable medium such as a programmable electronic circuit; a storage device such as a semiconductor memory device inclusive of volatile memory (e.g., random access memory, etc.) and/or non-volatile memory (e.g., any type of read-only memory “ROM,” flash memory) or a hard drive disk; or a portable storage device such as a floppy diskette, an optical disk (e.g., compact disk or digital video disk “DVD”).

Herein, the terms “rotate” and “pivot” as well as varying tenses thereof is generally defined as an angular movement about an axis of rotation. Normally, the axis of rotation is fixed where an item is “vertically” rotated (or pivoted) along a substantially horizontal axis of rotation and is “horizontally” rotated (or pivoted) along a substantially vertical axis of rotation.

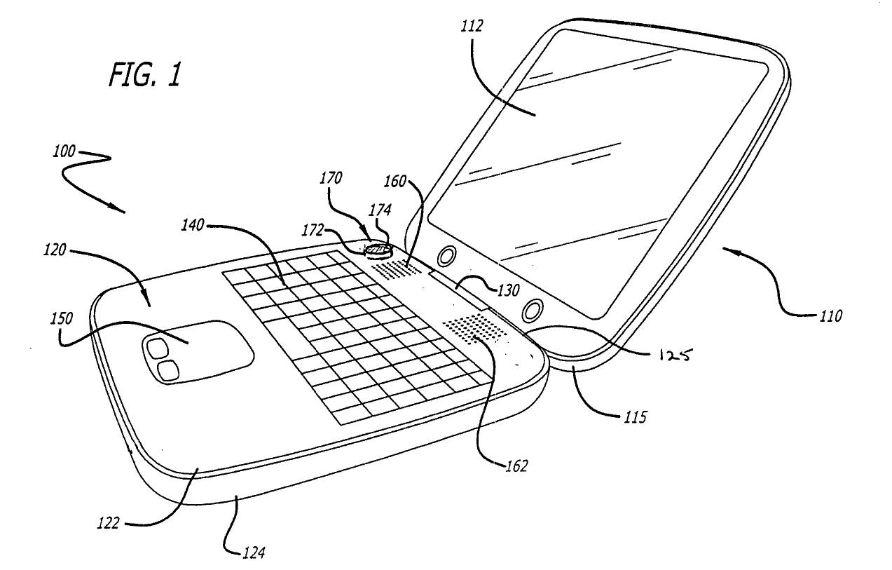

Referring to FIG. 1, a perspective view of an exemplary embodiment of a computer 100, such as a notebook PC placed in an operational state, is shown. Computer 100 comprises a display housing 110 that is pivotally coupled to a body case 120 through a hinge assembly 130.

As shown, display housing 110 is adapted to support a flat panel display 112 as well as circuitry placed within housing 110 for generating a displayable image on flat panel display 112. Examples of flat panel display 112 include, but are not limited or restricted to a liquid crystal display (LCD) for example.

Hinge assembly 130 is configured for coupling a top edge 125 of body case 120 to a bottom edge 115 of display housing 110. As one embodiment of the invention, hinge assembly 130 is adapted as any type of friction-based hinge (e.g., brake hinge) in order to maintain display housing 110 at selected angles of rotation above body case 120.

Body case 120 comprises a plurality of panel sections including a top panel 122 and a bottom panel 124. These panels 122 and 124 are coupled together with side panels in order to enclose hardware components placed internally within a cavity formed by panels 122 and 124. This protects the hardware components from foreign materials and environmental conditions. For this embodiment of the invention, panels 122 and 124 are made of non-pliable material such as synthetic resin, magnesium alloy, or even hardened plastic.

In an operational position, display housing 110 is pivotally raised above top panel 122 of body case 120 so that a user has access to a keyboard 140 and a secondary input device 150, such as a touch pad or track ball for example. Keyboard 140 as well as secondary input device 150 may be integrated into body case 120

In addition, dual speakers (not shown) are positioned within body case 120. Hence, pin-sized openings 160 and 162 are formed in body case 120 in order to allow audio produced by the speakers to be heard by the user. These openings 160 and 162 are visible when computer 100 is placed in the operational state as shown, and are covered by display housing 110 when computer 100 is closed and in a non-operational position.

According to this embodiment of the invention, a timer 170 is situated as part of body case 120 for use by a parent, teacher or any person monitoring usage of computer 100. As shown, timer 170 is a mechanical timer having a cylindrical knob 172 that normally protrudes from a top surface of top panel 122 partially forming body case 120. To set a selected period of time, knob 172 is rotated to a marking corresponding to a desired duration of time, and then is depressed to start the timer. During operation, knob 172 is maintained in a depressed position with a top surface 174 of knob 172 being substantially flush with the top surface of top panel 122. Once the selected period of time has elapsed, knob 172 pops up and an event occurs to advise the person monitoring usage that the desired amount of time has elapsed.

Alternatively, it is contemplated that timer 170 can be used to control the operations of computer 100. For instance, once timer 170 is set and the selected amount of time has elapsed, it may cause computer 100 to become inoperable. As an example, timer 170 may be adapted to cause computer 100 to initiate “shutdown” or enter into a sleep mode. Also, it may cause inoperability of flat panel display 112 or disable keyboard 140 and/or secondary input device 150.

Although not shown, it is contemplated that timer 170 may be implemented as an electronic timer with an LCD display in lieu of a mechanical timer.

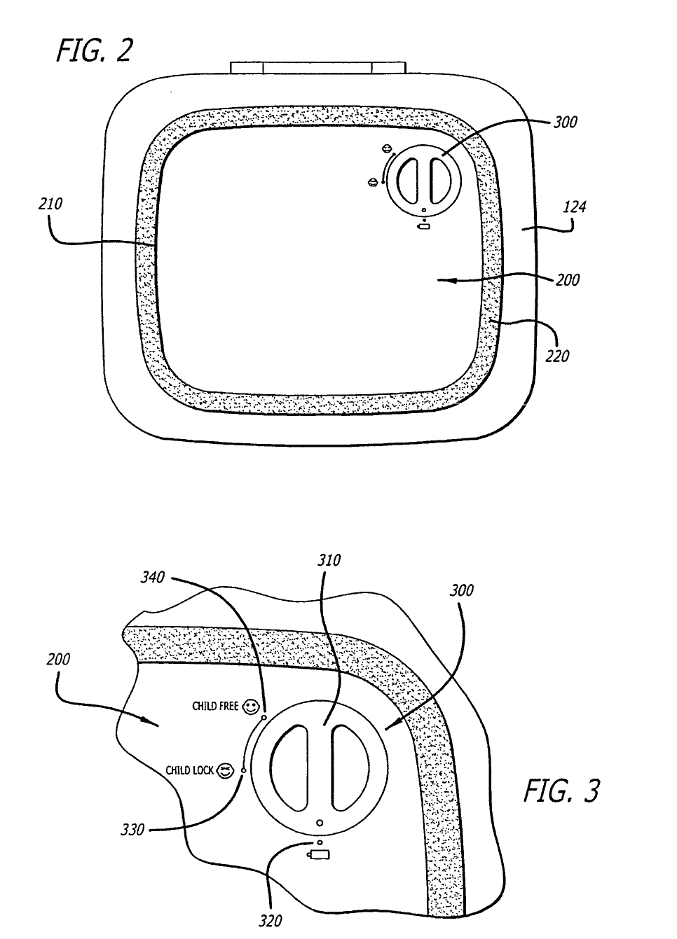

Referring now to FIG. 2, a top plan view of an exemplary embodiment of a bottom cover 200 is shown. Removably attached to bottom panel 124, bottom cover 200 is generally positioned equidistant from the edges of bottom panel 124 and, according to one embodiment of the invention, generally occupies a substantial percentage of the surface area of back panel 124 (e.g., fifty percent or more). Surrounding a perimeter 210 of bottom cover 200, a continuous pliable footing 220 is adapted with a selected height rising above the exterior surfaces of bottom panel 124 and bottom cover 200. Footing 220 provides sufficient friction to prevent computer 100 from sliding along a surface during use.

Back cover 200 further comprises a locking mechanism 300 that is adapted to secure and prevent removal of bottom cover 200 from panel 124. A more detailed illustration of an exemplary embodiment of locking mechanism 300 is shown in FIG. 3.

Herein, according to this embodiment of the invention, locking mechanism 300 comprises a cover locking device capable of being placed into a plurality of settings. According to one embodiment of the invention, as shown, the cover locking device may be a dial 310. However, it is contemplated that cover locking device may be designed in any form factor, provided that it can be placed in multiple settings.

When dial 310 is placed in a first setting 320 as shown, bottom cover 200 may be removed. In response either placement of dial 310 in first setting 320 or removal of bottom cover 200, the internal battery within computer 100 discontinues supplying power to various hardware components within computer 100. This prevents the user of computer 100, most likely a child, from being potentially harmed if bottom cover 200 is removed while computer 100 is in operation.

It is contemplated that the discontinuation of power may be instantaneous or may be prompted by execution of a particular software power-down routine. This software routine may be coded to (1) save any opened documents in a temporary folder, (2) save current settings for any running programs, and/or (3) initiate a power shutdown to safely turn off computer 100.

Dial 310 maybe placed in other settings, such as a second (child-lock) setting 330 and a third (child-free) setting 340. When placed in the second setting 330, dial 310 causes bottom cover 200 to be securely attached to bottom panel 124. Multiple embodiments for securely attaching bottom cover 200 to bottom panel 124 are described below. These embodiments, however, are merely illustrative and not exhaustive of attachment techniques that may be deployed for computer 100.

Additionally, when dial 310 is placed in the second setting 330, a lock detection mechanism (not shown), operating in cooperation with locking mechanism 300, produces signaling that causes computer power-ON restrictions or operating system (OS) user restrictions. For instance, “OS user restrictions” are designed to prevent the user from accessing logic components of computer 100 as well as stored content. As one example, when dial 310 is placed in the second setting 330, the lock detection mechanism produces a signal that, when processed, disables one or more internal logic components (e.g., modem, communication port, etc.). This may be used to prevent the user from communicating over a network (e.g., Internet) or with a peripheral device. According to another example, when dial 310 is placed in the second setting 330, the lock detection mechanism may be adapted to restrict access to content (e.g., application programs, files, documents, etc.) stored within computer 100.

Similarly, when placed in the third setting 340, dial 310 is positioned to cause bottom cover 200 to be securely attached to bottom panel 124. Moreover, the user will not be subject to usage or content restrictions as noted above. It is contemplated, however, that if in response to dial 310 being placed in the third setting 340, password protection software may be initiated to require the user to enter a password before any current usage and/or access restrictions are lifted. This would prevent a child from overriding restrictions merely by adjusting dial 310 from the second setting 330 to the third setting 340.

For clarity purposes, locking mechanism 300 and lock detection mechanism 500 (described below) are collectively referred to as a “control unit” for computer 100.

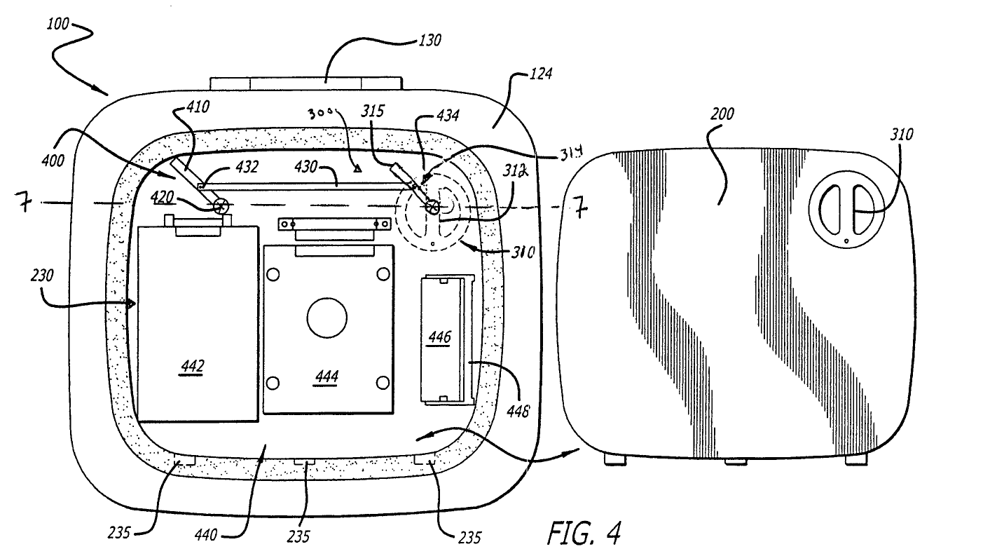

Referring now to FIG. 4, an exemplary embodiment of computer 100 is shown with bottom cover 200 removed and internal logic components of computer 100 accessible through an opening 230 design for bottom cover 200. As an optional feature, opening 230 comprises a plurality of recessed notches 235 to receive protrusions corresponding in size to notches 235 and placed along a selected side of bottom cover 200.

Placed in an unlocked position as shown, locking mechanism 300 comprises dial 310 and a lock-link mechanism 400. According to one embodiment of the invention, dial 310 features a first portion 312 placed external to body case 120 (represented by dashed lines) and a second portion 314 fixedly coupled to first portion 312. Second portion 314 comprises a pivotal first fastener 315 being a generally radial segment that is coupled to lock-link mechanism 400.

According to one embodiment of the invention, lock-link mechanism 400 comprises a second fastener 410 that is pivotally coupled about an axis of rotation 420 and coupled to first fastener 315 by an interconnecting member 430. Made of a rigid material such as metal or hardened plastic, member 430 comprises a first end 432 generally coupled about a mid-portion of second fastener 410 and a second end 434 generally coupled about a mid-portion of first fastener 315.

As shown herein, member 430 is utilized as a lever to control the engagement or disengagement of second fastener 410. More specifically, rotation and placement of dial 310 in the first setting causes fasteners 315 and 410 to be rotated in a first direction (e.g., counterclockwise direction). In this setting, fasteners 315 and 410 are fully maintained within an area formed by a perimeter for opening 230. Thus, bottom cover 200 may be removed from body case 120.

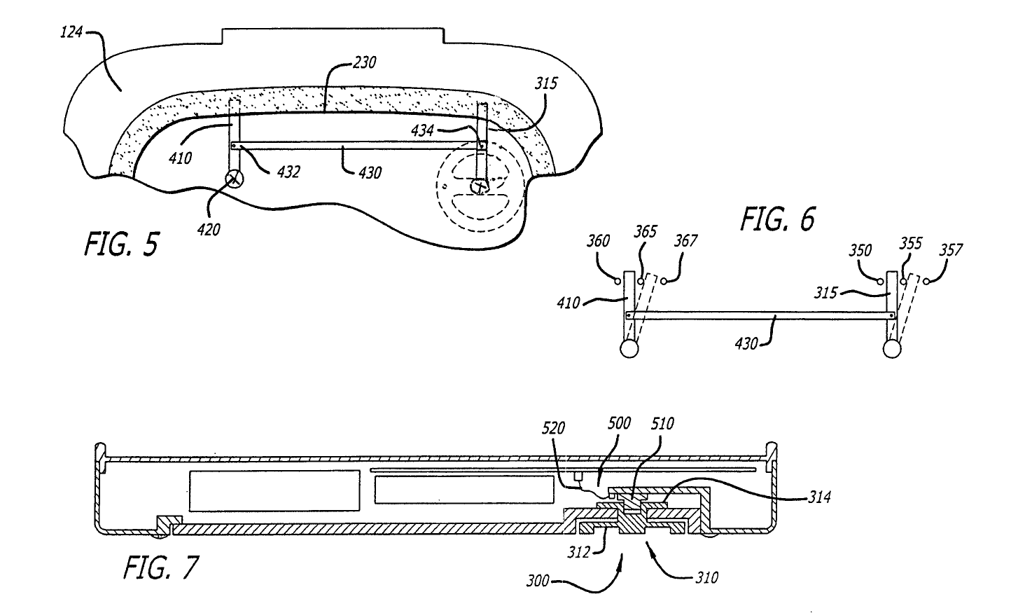

In the event that dial 310 is placed in the second or third settings, fasteners 315 and 410 would be rotated in a second direction (e.g., clockwise direction) so that portions of fasteners 315 and 410 are extended outside the perimeter for opening 230. Hence, as shown in FIG. 5, bottom cover 200 cannot be detached from body case 120.

More specifically, as shown in FIG. 5, when dial 310 is placed in the second or third settings, first fastener 315 is rotated, causing it to be positioned partially under bottom cover 200 and partially under bottom panel 124. Since second fastener 410 is movably coupled to first fastener 315 via interconnecting member 430, rotation of first fastener 315 causes a corresponding rotation of second fastener 410. As a result, second fastener 410 is partially covered by both bottom cover 200 and bottom panel 124 as well. This prevents bottom cover 200 from being removed.

Referring now to FIG. 6, a second exemplary embodiment of locking mechanism 300 placed in a lock position is shown. When dial 310 is placed in the second setting 330, first fastener 315 is positioned in an area between a first group of protrusions 350 and a second group of protrusions 355. These protrusions may be situated along an inner surface of back panel 124. Likewise, second fastener 410 is positioned in an area between a third group of protrusions 360 and a fourth group of protrusions 365. These protrusion groups 350/355 and 360/365 maintain fasteners 315 and 410 in a set position. Thus, a selected amount of rotational force needs to be applied (e.g., applied by rotation of dial 310) in order to free first and second fasteners 315 and 410 from the areas established between these protrusion groups 350/355 and 360/365. The same situation applies when dial 310 is placed in the third setting 340, where first fastener 315 is positioned between protrusion groups 355 and 357 while second fastener 410 is positioned between protrusion groups 365 and 367.

Referring back to FIG. 4, hardware components 440 are positioned within a cavity formed within body case 120 of computer 100 and are accessible once bottom cover 200 is removed. These components 440 include but are not limited to a battery 442, hard disk drive 444, and a memory 446 removably coupled to slot connector 448.

Referring now to FIG. 7, an exemplary cross-sectional view of locking mechanism 300 along with line 7-7 is shown. According to one embodiment of the invention, lock detection mechanism 500 is positioned to detect, by optic, magnetic and/or electrical means, the position of dial 310. According to this embodiment of the invention, lock detection mechanism 500 comprises a variable resistance switch 510 that is positioned integral to dial 310 of locking mechanism 300. As a result, operating in cooperation with second portion 314 of dial 310, variable resistance switch 510 is adapted to detect changes in voltage or resistance caused by rotation of switch 510 and to relay signals identifying such changes over interconnect 520. Interconnect 520 may be any medium that supports data transfer such as wire, bus trace, wireless communication pathway or the like.

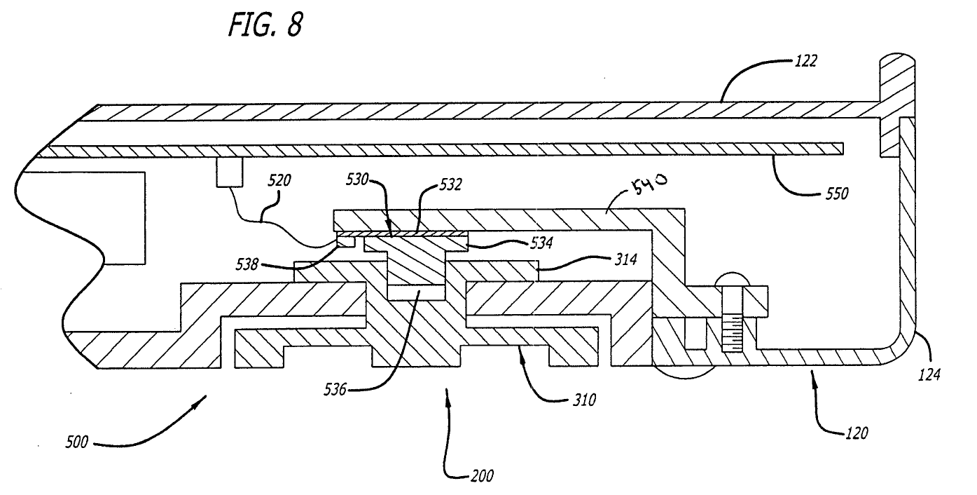

According to another embodiment of the invention, as shown in FIG. 8, lock detection mechanism 500 comprises a position measuring unit 530 placed on a support plate 540 attached to body case 120. As shown, according to this embodiment, position measuring unit 530 comprises a base 532 and a rotational column member 534 that is positioned integral to dial 310 of locking mechanism 200. For instance, rotational column member 534 may be inserted into and fixedly coupled to a recessed central area 536 of second portion 314 of dial 310. A sensor 538 (e.g. optical sensor) is positioned to detect positional changes of column member 534 when dial 310 is turned and to relay signals identifying such changes over interconnect 520.

As further shown, interconnect 520 provides signaling to a substrate 550, such as a printed circuit board for example, for routing to logic components mounted thereon or coupled to connectors mounted thereon. Substrate 550 is positioned in closer proximity to top panel 122 of body case 120 than bottom panel 124 and includes a plurality of connectors (not shown) adapted for coupling to battery 442, hard disk drive 444, and memory 446 of FIG. 4.

In the foregoing description, the invention is described with reference to specific exemplary embodiments thereof. It will, however, be evident that various modifications and changes may be made thereto without departing from the broader spirit and scope of the present invention as set forth in the appended claims. Therefore, the specification and drawings are accordingly to be regarded in an illustrative rather than in a restrictive sense.

What is claimed is:

1. A computer comprising:
a body case including a bottom panel having a single opening over a substantial area of the bottom panel;
a cover adapted for placement over the single opening and attachment to the body case; and
a control unit to (i) control attachment of the cover to the body case and (ii) impose a restriction for user access.

2. A computer according to claim 1, wherein the restriction comprises one of an operating system restriction, a content restriction and a power-on acces restriction.

3. A computer according to claim 1, wherein the control unit comprises a locking mechanism including a dial adapted for rotation between a plurality of settings, a first setting of the plurality of settings enables the cover to be detached from the body case and removed from the opening, a second setting of the plurality of settings causes the cover to become attached to the body case and imposes the restriction, and a third setting of the plurality of settings causes the cover to become attached to the body case without imposing the restriction.

4. A computer according to claim 3, wherein power supplied by a battery within the body case is suspended when the dial is placed in the first setting.

5. A computer according to claim 1, wherein the restriction includes disabling a component of the computer, thereby preventing communications over a network.

6. A computer according to claim 1, wherein the restriction includes limiting access to data stored on a memory.

7. A computer according to claim 1, wherein the control unit comprises:
a dial having a first portion rotational above a surface of the cover and a second portion rotational under the surface of the cover; and
a plurality of fasteners coupled together by an interconnecting member, the plurality of fasteners include (i) a first pivotal fastener coupled to the second portion of the dial and the interconnecting member and (ii) a second pivotal fastener coupled to the interconnecting member.

8. A computer according to claim 7, wherein the dial and the plurality of fasteners are part of the cover.

9. A computer according to claim 8, wherein the plurality of fasteners are fully maintained within a perimeter of the cover when the dial is placed in a first setting, the perimeter of the cover substantially corresponding to a size to a perimeter of the opening.

10. A computer according to claim 9, wherein the plurality of fasteners are positioned to extend outside the perimeter of the cover when the dial is placed in a second setting.

11. A computer according to claim 1 further comprising a timer positioned along a top panel partially forming the body case and visible to a user.

12. A computer according to claim 7, wherein the control unit further comprising (1) a variable resistance switch coupled to the dial and (2) a sensor to detect changes in a measured parameter caused by rotation of the variable resistance switch being rotated in response to rotation of the dial and to relay signals identifying the changes to a logic component implemented within the body case.

13. A locking mechanism for a removable cover formed as part of a body case of a computer, the locking mechanism comprising:
a cover locking device; and
a plurality of fasteners coupled to and controlled by the cover locking device, the plurality of fasteners to attach the cover to the body case when the cover locking device is placed in a first setting and to enable the cover to become detached from the body case when the cover locking device is placed in a second setting.

14. A locking mechanism according to claim 13, wherein the cover locking device is a dial configured to be rotated in a clockwise direction and in a counterclockwise direction.

15. A locking mechanism according to claim 14, wherein the plurality of fasteners are coupled together by an interconnecting member, a first end of the interconnecting member coupled to a first fastener of the plurality of fasteners and a second end of the interconnecting member coupled to a second fastener of the plurality of fasteners.

16. A locking mechanism according to claim 14 being in communication with a lock detection mechanism to detect a selected setting of the dial.

17. A locking mechanism according to claim 16, wherein in response to detecting the dial being placed in the second setting, the lock detection mechanism causes a discontinuation of a supply of power from a battery positioned within the body case.

18. A locking mechanism according to claim 17, wherein in response to detecting the dial being placed in the first setting, the lock detection mechanism to signal a processor within the body case to initiate an operating system user restriction, limiting functionality of the computer.

19. A locking mechanism according to claim 18, wherein the operating system user restriction includes disabling a logic component implemented within the body case of the computer.

20. A locking mechanism according to claim 16, wherein the lock detection mechanism comprises (1) a variable resistance switch coupled to the dial and (2) a sensor to measure changes in a resistance caused by rotation of the variable resistance switch and to relay a signal associated with the measured resistance to a processor implemented within the body case.

21. A computer comprising:
a body case including a plurality of panels interconnecting each other, a panel of the plurality of panels includes edges forming an opening in a substantial area of the panel;
a cover formed for placement over the opening and attachment to the body case; and
a locking mechanism including a cover locking device and a fastener being positioned to securely attach the cover to the body case when the cover locking device is placed in a first setting and positioned to enable removal of the cover from the body case when the cover locking device is placed in a second setting.

22. A computer according to claim 21, wherein the cover locking device is a dial positioned on the cover and fixedly coupled to the fastener so that rotation and placement of the dial in the first setting orients the fastener to extend beyond a perimeter formed by the opening and under the panel, and rotation and placement of the dial in the second setting orients the fastener to be remain completely within the perimeter formed by the opening.

23. A computer according to claim 21 further comprising a lock detection mechanism operating in cooperation with the locking mechanism, the lock detection mechanism to detect when the cover locking device is placed in the first setting, and in response, to limit access to stored content within the computer.

24. A computer according to claim 21 further comprising a lock detection mechanism operating in cooperation with the locking mechanism, the lock detection mechanism to detect when the cover locking device is placed in the first setting, and in response, to disable a logic component implemented within the body case.
